(19) United States
(12) Patent Application Publication
(10) Pub. No.: US 2020/0363104 A1
(43) Pub. Date: Nov. 19, 2020

(54) THERMOELECTRIC COOLING SYSTEM WITH SUB-AMBIENT COOLING AND CONDENSATION CONTROL FOR A COMPUTING DEVICE

(71) Applicant: Intel Corporation, Santa Clara, CA (US)

(72) Inventors: Mark MacDonald, Beaverton, OR (US); Akhilesh P. Rallabandi, Portland, OR (US); Genevieve L. Gaudin, Corvallis, OR (US); Daniel J. Ragland, Sherwood, OR (US); Rodny Rodriguez, Beaverton, OR (US); Felipe Gonzalez, Folsom, CA (US); Hui Xiong, Portland, OR (US); Sai Goutham Ponnada, Folsom, CA (US); Christoph Jechlitschek, Hillsboro, OR (US)

(73) Assignee: Intel Corporation, Santa Clara, CA (US)

(21) Appl. No.: 16/945,181

(22) Filed: Jul. 31, 2020

(51) Int. Cl. F25B 21/02; G06F 1/20

(52) U.S. Cl. CPC F25B 21/02; F25B 2321/0252; F25B 2321/0212; G06F 1/20

(57) ABSTRACT

In one embodiment, a computing device includes a processor, a water block, a thermoelectric cooler, and a thermal space transformer. The thermoelectric cooler is disposed in series between the processor and the water block, and the thermoelectric cooler includes a heated surface and a cooled surface. The heated surface is thermally coupled to the water block, and the cooled surface is thermally coupled to the processor via the thermal space transformer. The thermal space transformer transfers thermal energy between the processor and the cooled surface of the thermoelectric cooler. The thermal space transformer includes a smaller surface and a larger surface. The smaller surface is thermally coupled to the processor and the larger surface is thermally coupled to the cooled surface of the thermoelectric cooler.

### FIELD OF THE SPECIFICATION

This disclosure relates in general to the field of thermal control and cooling of computing devices, and more particularly, though not exclusively, to a thermoelectric cooling system with sub-ambient cooling and condensation control for a computing device.

### BACKGROUND

Effective cooling solutions are crucial to maximizing the performance of computing devices. For example, operating a processor or CPU above the maximum frequency that it has been designed to run at—commonly referred to as “overclocking”—typically requires cooling to be provided at sub-ambient temperatures. Traditional cooling solutions, however, are either incapable of achieving sub-ambient cooling temperatures, or they are otherwise ineffective, overly susceptible to condensation, and/or too impractical or expensive for mainstream adoption.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates a cross-section schematic of a computing device with a thermoelectric cooling system in accordance with certain embodiments.

FIGS. 2A-D illustrate an example embodiment computing device with a thermoelectric cooling system in accordance with certain embodiments.

FIG. 3 illustrates a performance evaluation of the proposed thermoelectric cooling (TEC) solution versus an off-the-shelf liquid cooler.

FIG. 4 illustrates an example of the thermal control functionality for a computing device with a thermoelectric cooling system.

FIG. 5 illustrates a graph of the thermal resistance of a thermoelectric cooler in an unpowered state with an open circuit versus a shorted circuit.

FIG. 6 illustrates a flowchart for dynamically controlling the thermal conditions and performance of a processor using a thermoelectric cooler.

FIG. 7 illustrates an example of a computing device that leverages thermoelectric cooling functionality.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

Effective cooling solutions are crucial to maximizing the performance of computing devices. In particular, operating a processor or CPU above the maximum frequency that it has been designed to run at—which is commonly referred to as “overclocking”—typically requires cooling to be provided at sub-ambient temperatures. As an example, operating below ambient temperature is key to reaching peak processor performance for enthusiast overclockers seeking to improve performance beyond what is possible with traditional liquid and air cooling solutions (e.g., water blocks, water-cooled loops, fans), as those solutions are typically limited to cooling at ambient temperature and cannot achieve sub-ambient cooling temperatures. Moreover, while Liquid Nitrogen (LN2) can be used for this purpose, it is expensive, dangerous, and not readily available for most consumers.

Further, while thermoelectric coolers (TEC) can be used to enhance CPU cooling to reach sub-ambient temperatures, existing TEC solutions suffer from various shortcomings, including poor cooling efficacy, poor efficiency, and moisture condensation issues. For example, attempts to make thermoelectrically enhanced desktop cooling solutions have never shown real performance advantages under high CPU loads, such as when CPUs are overclocked. Thus, no existing thermoelectric cooling solutions are capable of providing sub-ambient CPU cooling at high loads (e.g., over 100 watts (W)) in a cost-effective end-user form factor. Existing thermoelectric cooling solutions also suffer from very low efficiency, as they consume disproportionally high amounts of electrical energy relative to the level of cooling they are designed to provide. Further, existing thermoelectric cooling solutions suffer from condensation issues. Condensation is particularly difficult to avoid in any system where the temperature of the cooler is lowered below the ambient temperature. For example, a thermoelectric cooler can produce a substantial difference in temperature between its hot and cold sides, which may cause the cold side to become significantly colder than its ambient surroundings. This ultimately leads to condensation, which can be catastrophic to electrical circuitry and components.

Accordingly, this disclosure presents various embodiments of a thermoelectric cooling (TEC) solution for a computing device that alleviates the shortcomings of existing solutions. In particular, the proposed TEC solution offers improved cooling efficacy, sub-ambient cooling capabilities, dynamic cooling and condensation control, and dynamic thermal velocity control, which collectively serve to maximize the overall performance that can be achieved by a processor (e.g., by increasing the maximum frequency/speed at which the processor core(s) are capable of operating).

For example, the proposed solution places a thermoelectric cooler (TEC) for a computing device in a novel configuration designed to improve cooling efficacy and achieve sub-ambient cooling temperatures, while minimizing the total surface area and volume of exposed cold surfaces that reach sub-ambient temperatures (e.g., in order to minimize condensation potential). In particular, the thermoelectric cooler (TEC) is placed in series between the processor and the primary water block (or another suitable cooling mechanism), with the cooled surface of the TEC facing the processor and the heated surface of the TEC facing the water block. Moreover, due to the typical size difference between the processor and the TEC, a thermal space transformer (TST) is placed between the processor and the TEC to reduce thermal resistance and increase the transfer of thermal energy—and thus spread heat more effectively—from the smaller processor to the larger cooled surface of the TEC. For example, the thermal space transformer may be a block of thermally conductive material (e.g., copper (Cu) or another metal) with two surfaces of different sizes—a smaller surface and a larger surface—which are respectively thermally coupled with the smaller processor and the larger TEC.

In this configuration, the cooled surface of the TEC serves to cool the processor (e.g., via the effective thermal coupling provided by the thermal space transformer), while the heated surface of the TEC is cooled by the water block. As a result, this configuration helps balance the temperature on each side of the TEC to achieve a relatively uniform temperature on both sides, which is crucial to overcoming the inherent inefficiency of the TEC so it can serve as a viable cooling solution.

Further, in some embodiments, the computing device is protected from condensation using an anticondensation shroud in conjunction with dynamic cooling and condensation control. For example, an anticondensation shroud (e.g., with active chemical desiccation) is used to isolate the electronic components and protect them from condensation, while dynamic cooling and condensation control is used to manage operation above dew point and minimize the risk of condensation.

In this manner, the proposed TEC solution can achieve sub-ambient cooling temperatures with improved efficiency and efficacy—without succumbing to condensation—which maximizes the overall performance that can be achieved by a processor by enabling it to operate at frequencies/speeds beyond its intended maximum.

The proposed solution includes numerous points of novelty, as demonstrated by the following non-limiting list of example novel aspects:
1. An end-user or consumer friendly thermal control solution capable of running processors beyond their maximum intended frequency while maintaining a low silicon junction temperature (e.g., running a CPU at 5.8 GHz with a junction temperature of only 30 degrees Celsius (° C.));
2. A thermoelectric cooling device embedded in series between a processor and a traditional cooling mechanism—such as between the CPU and the water block of a traditional desktop high-end liquid cooling solution—to minimize the total potential exposed surface area below ambient temperature in order to minimize condensation potential;
3. A small socket-mated anticondensation shroud for isolation of electronic components, with or without renewable chemical desiccants, to eliminate condensation at exposed cold surfaces;
4. Software control of cold surface temperatures to manage condensation risk and allow for dew point control and/or sub-dew point risk management during temporary peak performance excursions, including transient excursions based on workload anticipation and user risk tolerance settings;
5. Temperature prediction of exposed cold surfaces using software driver based monitoring of the CPU density factor as well as instantaneous power and junction temperature;
6. Dynamic dew point monitoring using an integrated humidity sensor within a TEC controller board to facilitate a controlled response to the risk of condensation;
7. “Thermal Affinitizers” to concentrate processor affinities—or allocations of processor cores—for certain tasks or workloads to maximize the performance/frequency of the cores used to execute those tasks in conjunction with the sub-ambient TEC cooler (e.g., concentrating the cores allocated to Simultaneous Multithreading (SMT) threads to enable faster execution); and
8. A self-powered mode to improve energy efficiency and reduce power consumption during normal (e.g., non-overclocked) operating conditions—up to and including thermal design power (TDP) workloads—by powering off and short-circuiting the TEC module, which reduces thermal impedance by up to ⅓^{rd} without having to power the TEC cooler, thus significantly improving everyday system efficiency and power consumption.

The proposed solution provides numerous advantages. For example, the sub-ambient cooling system enables the creation of a personal or desktop computer with a CPU capable of running at 5.8 GHz. In order to hit this frequency, the silicon junction temperature must be maintained at 30° C. (under load). The sub-ambient cooler described herein is able to achieve this operating condition. For overclockers, the proposed solution delivers real world overclocking performance gains (e.g., 1-3 bins or 100-300 MHz increase in maximum frequency) above and beyond what is possible with the current best-in-class thermal solutions (e.g., the best liquid coolers currently on the market), while simultaneously providing a solution for the mitigation of moisture condensation, and is the first safe and affordable consumer solution for sub-ambient cooling in the gaming/overclocking desktop market. The proposed solution also includes functionality that targets the prevention of condensation, synergistic thread and power management, and a self-powered TEC mode that is unique to the novel configuration of this solution.

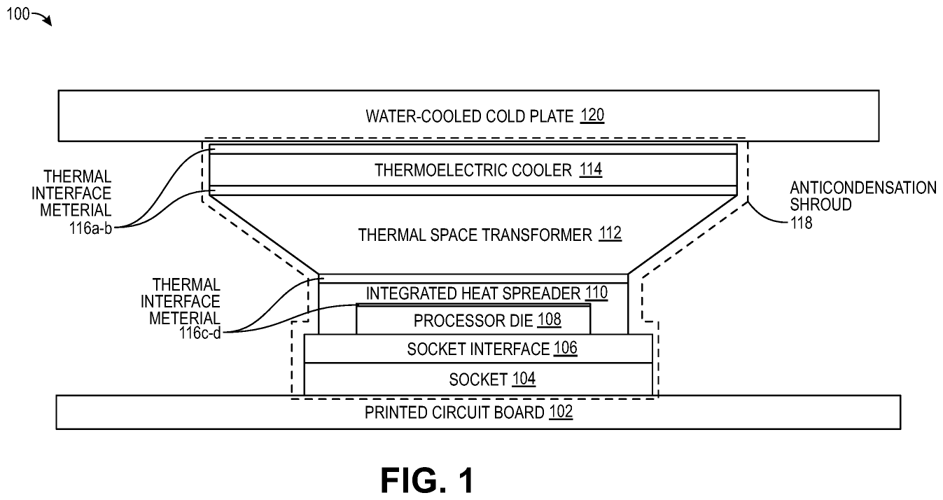

FIG. 1 illustrates a cross-section schematic of a computing device 100 with a thermoelectric cooling system in accordance with certain embodiments. In the illustrated embodiment, the computing device 100 includes a printed circuit board (PCB) 102 (e.g., a motherboard), a socket 104, a processor (CPU) socket interface 106, a processor (CPU) die 108, an integrated heat spreader (IHS) 110, a thermal space transformer (TST) 112, a thermoelectric cooler (TEC) 114, various thermal interface material (TIM) layers 116a-d, an anticondensation shroud 118, and a water-cooled cold plate 120 of a water block, as described further below.

In the illustrated embodiment, the thermoelectric cooler (TEC) 114 for the computing device 100 is placed in a novel configuration designed to improve cooling efficacy and achieve sub-ambient cooling temperatures, while minimizing the total surface area and volume of exposed cold surfaces that reach sub-ambient temperatures (e.g., in order to minimize the risk of condensation). For example, the TEC 114 is placed, embedded, or disposed in series between the processor 108 and a water-cooled cold plate 120 of a water block (or another suitable cooling mechanism), with the cooled surface of the TEC 114 facing the processor 108 and the heated surface of the TEC 114 facing the cold plate 120 of the water block.

Moreover, due to the typical size difference between the processor 108 and the TEC 114, a thermal space transformer (TST) 112 is placed between the processor 108 and the TEC 114 to reduce thermal resistance and increase the transfer of thermal energy—and thus spread heat more effectively—from the smaller processor 108 to the larger cooled surface of the TEC 114. For example, the thermal space transformer 112 may be a block of thermally conductive material (e.g., copper (Cu) or another metal) with two surfaces of different sizes—a smaller surface and a larger surface—which are respectively thermally coupled to the smaller processor 108 and the larger TEC 114.

In this configuration, the cooled surface of the TEC 114 serves to cool the processor 108 (e.g., via the effective thermal coupling provided by the thermal space transformer 112), while the heated surface of the TEC 114 is cooled by the cold plate 120 of the water block. As a result, this configuration helps balance the temperature on each side of the TEC 114 to achieve a relatively uniform temperature on both sides, which is crucial to overcoming the inherent inefficiency of the TEC 114 so it can serve as a viable cooling solution. Further, this configuration minimizes the total volume and extent of sub-ambient temperature surfaces, which helps minimize the risk of condensation.

Further, in some embodiments, the computing device 100 may include additional features for protecting against condensation, such as an anticondensation shroud 118 in conjunction with dynamic cooling and condensation control. The anticondensation shroud 118 is used as a shield to isolate and protect certain electronic components from condensation, while dynamic cooling and condensation control is used to manage operation of the TEC 114 above dew point to minimize the risk of condensation, as described further below.

In some embodiments, for example, the anticondensation shroud 118 is implemented as a small socket-mated “fence” that forms an airtight enclosure around certain components of the computing device 100 to protect them from external ambient air and condensation, such as the processor 108, the TEC 114, and the thermal space transformer 112. In particular, the shroud 118 is designed to form a wall or fence around the protected components, while also mating with the socket 104 or printed circuit board 102 and the water block 120 to seal the respective openings below and above the protected components. For example, the bottom rim of the shroud 118 is designed to mate with the socket 104 or printed circuit board 102, while the top rim of the shroud 118 is designed to mate with the water block 120 (or another cooling mechanism), thus effectively forming a floor and a ceiling around the protected components. In this manner, the shroud 118 forms an airtight enclosure around all components positioned between the printed circuit board 102 and the water block 120—including the processor 108, the TEC 114, and the thermal space transformer 112—which isolates those components and completely encloses all exposed cold surfaces to help prevent condensation and moisture. Moreover, the shroud 118 can be used effectively either with or without renewable chemical desiccants, depending on the particular embodiment.

Further, in some embodiments, dynamic cooling and condensation control logic is used to manage operation of the TEC 114 and maintain temperatures above dew point, or within certain set points, to minimize the risk of condensation. In some embodiments, for example, dynamic cooling and condensation control is implemented using a thermoelectric cooling (TEC) controller for controlling the voltage or cooling power of the TEC 114, an integrated humidity sensor for measuring humidity within the computing device 100, thermal sensors for measuring temperatures within the computing device 100 (e.g., temperatures of the processor 108, processor core(s), and/or other surfaces or components within the computing device 100 and/or shroud 118), and thermal/power data for the processor 108 (e.g., provided by software drivers) for predicting temperatures of certain surfaces or components within the device 100 (e.g., predicting temperatures of cold surfaces of the TEC 114/thermal space transformer 112, or the temperature of the printed circuit board/motherboard 102, based on temperatures measured by processor thermal sensors).

For example, the TEC controller is used to monitor thermal conditions within the computing device 100 (e.g., temperature/humidity), and based on the thermal conditions, dynamically adjust the voltage or cooling power of the TEC 114 to maximize processor performance while preventing or minimizing the risk of condensation. In some cases, for example, the TEC controller may dynamically adjust the TEC 114 voltage to maintain temperatures above dew point to avoid condensation, or otherwise maintain temperatures within certain set points (e.g., specified by software or a user) to minimize the risk of condensation during temporary operation below dew point for certain workloads (e.g., for peak processor performance at the maximum clock frequency).

In some embodiments, for example, the TEC controller and the integrated humidity sensor are both enclosed in the anticondensation shroud 118 and are used to monitor humidity within the shroud 118. Moreover, temperatures of the processor 108, the printed circuit board 102, and other components/surfaces within the shroud 118 may be monitored using thermal sensors and/or thermal temperature predictions.

For example, the processor 108 may include a collection of thermal sensors that are used to measure the temperatures of its respective processing cores. Moreover, in some embodiments, the printed circuit board 102 (e.g., motherboard) and/or certain component(s) within the shroud 118 (e.g., the TEC 114 and/or thermal space transformer 112) may also include dedicated thermal sensors to measure their respective temperatures. In other embodiments, however, those components may not have their own thermal sensors, and instead, their temperatures may be predicted based on: (i) the processor temperatures measured by the thermal sensors of the processor 108; and (ii) thermal/power data for the processor 108 obtained from software drivers. For example, the processor temperatures and thermal/power data for the processor 108 may be used to predict the temperature of the printed circuit board 102 (e.g., motherboard), the temperatures of cold surfaces within the shroud 118 (e.g., cold surfaces of the TEC 114 and/or thermal space transformer 112), and so forth. As a result, by leveraging temperature predictions for certain components, dedicated thermal sensors for those components can be omitted, thus reducing both cost and complexity.

In this manner, based on the thermal conditions observed within the computing device 100, the TEC controller can then dynamically adjust the voltage or cooling power of the TEC 114 to provide precise dew point temperature control, thus avoiding condensation or otherwise managing the risk of condensation while maximizing processor performance.

The processor 108 may be or otherwise include any type of processing or electronic circuitry, such as a central processing unit (CPU), graphics processing unit (GPU), microprocessor, microcontroller, accelerator, field-programmable gate array (FPGA), and so forth.

The thermoelectric cooler (TEC) 114 may include any cooling device or mechanism that relies on, or operates using, thermoelectricity and/or the Peltier effect. For example, the TEC 114 may be a device with two surfaces—or metallic plates—that have electronic junctions sandwiched between them, which are designed to transfer or pump thermal energy from one surface to the other when current or voltage is applied. In this manner, one surface is cooled while the other is heated, thus resulting in a cooled surface and a heated surface.

The thermal space transformer 112 may be a block of any type of thermally conductive material(s) designed to reduce thermal resistance and increase the transfer of thermal energy—and thus spread heat more effectively—between the processor 108 and the thermoelectric cooler 114. In some embodiments, for example, the thermal space transformer 112 may be made from a metal with high thermal conductivity, such as copper (e.g., a copper space transformer). Further, in some embodiments, the thermal space transformer 112 may be implemented as a thermal interposer (e.g., a copper interposer).

The water-cooled cold plate 120, or water block, may include any type of water- or liquid-based cooling mechanism. Moreover, in various embodiments, other types of cooling mechanisms may be used instead of, or in addition to, a water-cooled cold plate 120 or water block.

The integrated heat spreader 110 may be a block of any type of thermally conductive material(s)—such as copper, aluminum, and/or diamond—that is integrated with the processor die 108 and/or otherwise designed to help spread heat generated by the processor.

The thermal interface material (TIM) layers 116a-d may be layers of any type of thermally conductive material(s) designed to improve thermal conductivity between or among components and/or layers of the computing device 100.

The socket 104 and/or socket interface 106 may include any component(s) or mechanism(s) designed to couple or mate (e.g., mechanically and/or electrically) the processor die 108 and the printed circuit board 102. For example, the socket 104 may be coupled to the printed circuit board 102 while the socket interface 106 may be coupled to the processor die 106, and the socket interface 106 may be designed to mate with the socket 104 in order to couple the processor die 108 to the printed circuit board 102.

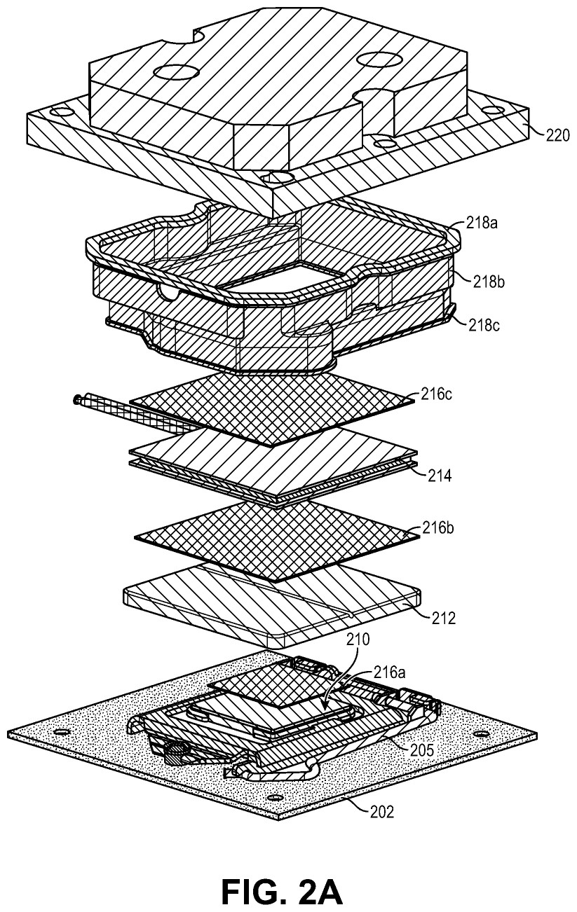

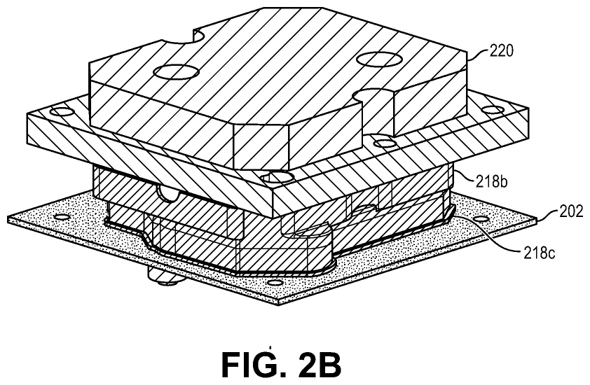

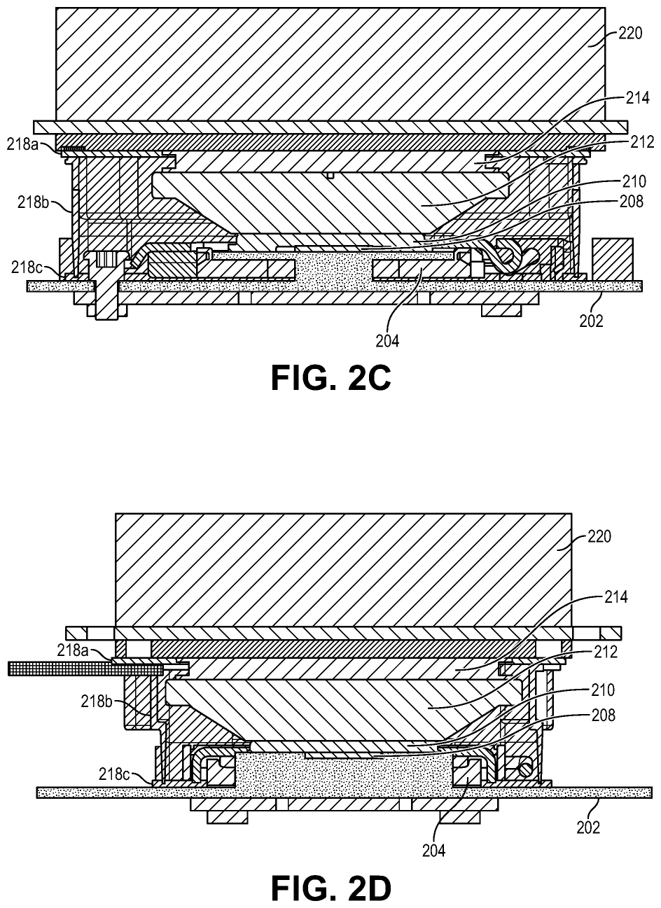

FIGS. 2A-D illustrate an example embodiment of a computing device 200 with a thermoelectric cooling system in accordance with certain embodiments. In particular, FIGS. 2A-D illustrate various perspectives of the computing device 200, which collectively capture and depict the arrangement of components within the device. For example, FIG. 2A illustrates the computing device 200 in a disassembled state showing its overall arrangement of components, FIG. 2B illustrates the computing device 200 in an assembled state (e.g., with certain components hidden from view), and FIGS. 2C-D illustrate cross-section views of the computing device 200 in an assembled state.

In the illustrated embodiment, the computing device 200 includes a printed circuit board (PCB) 202 (e.g., motherboard), a socket 204, an independent loading mechanism (ILM) 205 (e.g., to securely load the processor 208 into the socket 204), a processor 208 (e.g., a CPU), an integrated heat spreader (IHS) 210, a thermal space transformer 212, a thermoelectric cooler (TEC) 214, various thermal interface material (TIM) layers 216a-c, an anticondensation shroud 218a-c, and a water block 220. Some or all of these components may be similar to corresponding components from FIG. 1 with similar reference numerals, which are described in detail above and throughout this disclosure.

As shown in the illustrated embodiment, the shape of the anticondensation shroud 218a-c matches the geometry of the socket 204, which allows them to securely mate. In particular, the anticondensation shroud 218a-c is collectively formed by a top shroud gasket 218a, a shroud body 218b, and a bottom shroud gasket 218c. The top shroud gasket 218a is designed to mate with the water block 220 (or another cooling mechanism), while the bottom shroud gasket 218c is designed to mate with the socket 204 on the printed circuit board 202. Further, the shroud body 218b is designed to form a wall or fence around all components located between the printed circuit board 202 and the water block 220. In this manner, the shroud body 218b and gaskets 218a,c collectively form an airtight enclosure around all components positioned between the printed circuit board 202 and the water block 220—including the processor 208, the TEC 214, and the thermal space transformer 212—which isolates those components and completely encloses all exposed cold surfaces to help prevent condensation and moisture.

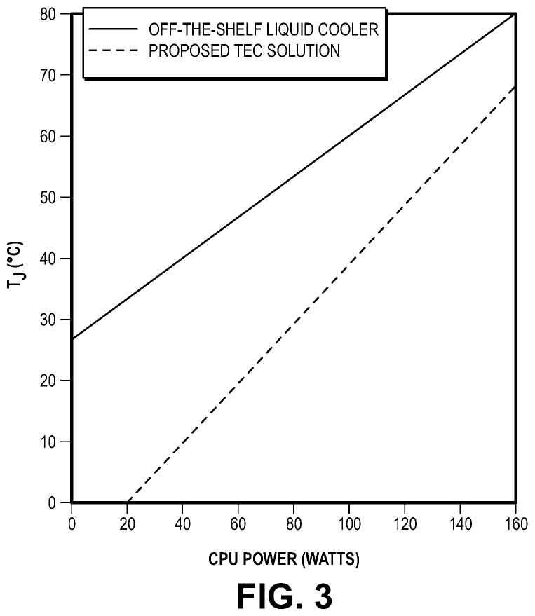

FIG. 3 illustrates a performance evaluation of the proposed thermoelectric cooling (TEC) solution versus an off-the-shelf liquid cooler. In particular, the performance evaluation depicts a graph of the silicon junction temperature (Tⱼ° C.) achieved by each cooling solution depending on the amount of power supplied to the CPU. As shown by the performance graph, the proposed TEC solution achieves significantly lower silicon junction temperatures (Tⱼ) than the off-the-shelf liquid cooler. While these performance results are based on delivering 270 watts (W) of power to the TEC, more than 90% of that performance upside is observed with only 160 W of applied power to the TEC, which is easily available from a 12V rail power supply (e.g., through a standard 9-pin connector).

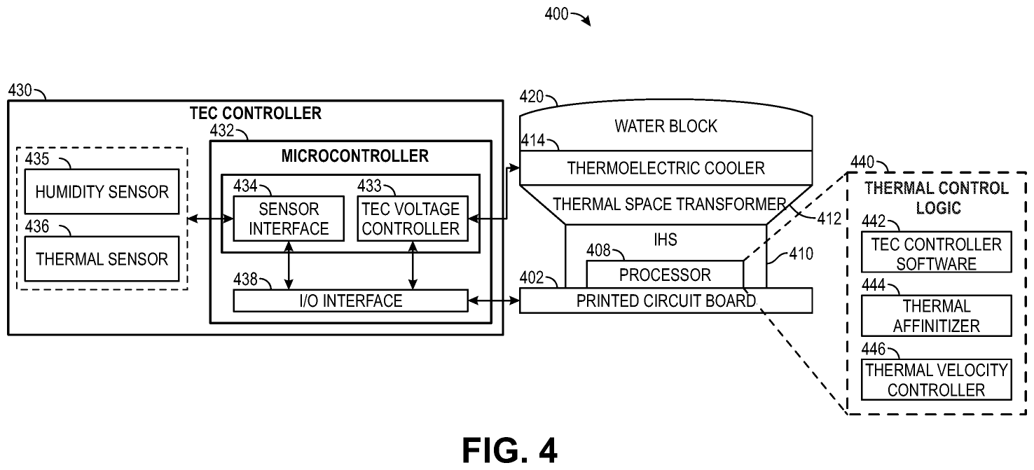

FIG. 4 illustrates an example of the thermal control functionality for a computing device 400 with a thermoelectric cooling system. In the illustrated embodiment, the computing device 400 includes a printed circuit board 402, a processor 408, an integrated heat spreader 410, a thermal space transformer 412, a thermoelectric cooler 414, and a water block 420. The computing device 400 may also include an anticondensation shroud (not shown) to protect various components from condensation. These components may be similar to corresponding components from FIGS. 1-2 with similar reference numerals, which are described in detail throughout this disclosure.

In the illustrated embodiment, the computing device 400 also includes thermal control logic 440 and a thermoelectric cooler (TEC) controller 430. The thermal control logic 440 includes TEC controller software 442, a thermal affinitizer 444, and a thermal velocity controller 446. The TEC controller software 442 is used to control the operation of the TEC controller 430, the thermal affinitizer 444 is used to strategically assign processor affinities and core allocations to optimize thermal conditions and performance for execution of certain tasks, and the thermal velocity controller 446 is used to perform automatic frequency control for the processor 408 based on thermal conditions and/or configurable overclocking settings, as described further below. In various embodiments, the thermal control logic 440 can be implemented using any combination of hardware and/or software logic, including hardware circuitry, microcode, firmware (e.g., BIOS/UEFI), operating system (OS) software and drivers, and so forth.

The TEC controller 430 is used in conjunction with the TEC controller software 442 to monitor thermal conditions within the computing device 400 (e.g., temperature/humidity) and manage operation of the TEC 414 to maintain temperatures above dew point, or within certain set points, to minimize the risk of condensation while maximizing processing performance.

In the illustrated embodiment, for example, the TEC controller 430 includes a microcontroller 432 with a TEC voltage controller 433 for controlling the voltage or cooling power of the TEC 414, a sensor interface 434 for obtaining humidity and/or temperature measurements from an integrated humidity sensor 435 and/or thermal sensor 436, and an input/output (I/O) interface for communicating with the computing device 400 (e.g., a USB interface).

The operation of the TEC controller 430 is controlled by TEC controller software 442 running on the processor 408 (e.g., an operating system (OS) driver). The TEC controller 430, in conjunction with the TEC controller software 442 executing on the processor 408, monitors thermal conditions within the computing device 400 (e.g., temperature/humidity), and based on the thermal conditions, dynamically adjusts the voltage or cooling power of the TEC 414 to prevent or minimize the risk of condensation. In some cases, for example, the TEC controller 430 may dynamically adjust the TEC 414 voltage to maintain temperatures above dew point to avoid condensation, or otherwise maintain temperatures within certain set points (e.g., specified by software or a user) to minimize the risk of condensation during temporary operation below dew point for certain workloads (e.g., for peak processor performance at the maximum clock frequency).

In some embodiments, for example, the TEC controller 430, the integrated humidity sensor 435, and/or the integrated thermal sensor 436 may be enclosed within the anticondensation shroud (not shown) to monitor thermal conditions within the shroud (e.g., temperature/humidity). For example, the humidity sensor 435 may be used to measure the humidity within the shroud, and the thermal sensor 436 may be used to measure the temperature of exposed cold surface(s) within the shroud (e.g., cold surfaces of the TEC 414 and/or thermal space transformer 412).

In other embodiments, however, the TEC controller 430 may not include an integrated thermal sensor 436, and instead, the temperature of cold surfaces within the shroud may be predicted based on thermal/power data for the processor 408, which may be obtained from software drivers. For example, the processor 408 may include a collection of thermal sensors that are used to measure the temperatures of its respective processing cores (e.g., the silicon junction temperatures). Moreover, the instantaneous silicon junction temperatures and power levels of the CPU, along with the CPU density factor for the particular type or make/model of CPU, can be obtained using software driver-based thermal management hooks based on the CPU identity (e.g., determined via the CPUID instruction or another similar mechanism for determining CPU identity). These thermal/power characteristics for the CPU (e.g., the instantaneous silicon junction temperatures and power levels, and the CPU density factor) effectively serve as a thermal fingerprint for the CPU, which can be used to accurately predict the temperature of cold surface(s) within the anticondensation shroud, such as cold surfaces of the TEC 414 and/or thermal space transformer 412. A similar approach can also be used to predict the temperature of other components or surfaces of the computing device 400, such as the temperature of the printed circuit board 402 (e.g., motherboard).

In this manner, the use of temperature predictions for certain surfaces and/or components of the computing device 400 eliminates the need to have dedicated thermal sensors for those components, which allows those thermal sensors to be omitted from the computing device 400. For example, the use of temperature predictions to predict the temperature of cold surfaces within the shroud allows the thermal sensor(s) 436 of the TEC controller 430 to be omitted. Similarly, the use of temperature predictions to predict the temperature of the printed circuit board 402 (e.g., motherboard) allows thermal sensor(s) associated with the printed circuit board 402 to be omitted.

The thermal conditions observed within the computing device 400—such as the processor 408 silicon junction temperatures, the PCB/motherboard 402 temperature, the cold surface temperature(s) of the TEC 414 and/or thermal space transformer 412, and the humidity—can then be used to manage operation of the TEC 414.

For example, based on these thermal conditions, TEC controller software 442 can cause the TEC controller 430 to dynamically adjust the voltage or cooling power of the TEC 414 to achieve various performance related objectives, such as reducing the processor silicon junction temperatures to maximize processor performance (e.g., increase the processor frequency/speed), while also preventing or minimizing the risk of condensation.

For example, the current humidity measured within the computing device 400 can be used to precisely determine the current dew point for the device. The dew point, along with the measured or predicted cold surface temperature(s) within the device 400 (e.g., cold surface temperature(s) of the thermal space transformer 412 and/or TEC 414), can be used to accurately predict the current risk of condensation for the device.

The target cooling temperature for the TEC 414 can then be dynamically set based on the risk of condensation along with other thermal conditions and performance criteria, such as current processor silicon junction temperatures, current processor frequency/speed, target processor frequency/speed, workload type and/or requirements, user-specified target minimum and/or maximum temperatures, and/or any other configurable risk tolerance settings (e.g., specified by software or a user).

In some embodiments, the thermoelectric cooler (TEC) 414 also supports a self-powered mode that can be activated or configured by the TEC controller 430 by simply powering off and short-circuiting the TEC 414, which causes the TEC 414 to become a self-powered device with reduced thermal impedance. In this manner, the self-powered mode can be leveraged in low power operation to improve energy efficiency and reduce power consumption during normal (e.g., non-overclocked) operating conditions (e.g., up to and including thermal design power (TDP) workloads).

The self-powered mode is activated by simply powering off and short-circuiting the TEC 414, which reduces its thermal impedance by up to ⅓^{rd} without consuming any power, thus significantly improving everyday system efficiency and power consumption. This self-powered mode is possible due to the novel configuration of this TEC cooling solution, with the TEC 414 located in series between the processor 408 and the water block 420. As a result of this configuration, short-circuiting the TEC 414 allows it to operate as a thermoelectric generator (TEG).

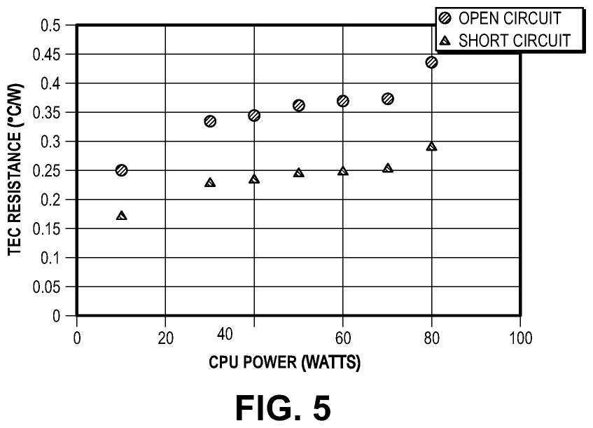

For example, the temperatures of the “cold surface” and “hot surface” of the TEC 414 during normal operation are reversed from their normal polarity when the TEC 414 is in self-powered mode. In particular, since no power is being supplied to the TEC 414 in self-powered mode, the “cold surface” is now at a higher temperature due to the heat from the CPU 408 case, and the “hot surface” is now at a lower temperature due to the cooling from the water block 420. In this state, the material work functions create voltage bias that drives a small current that effectively self-powers the device. The net impact of this is a full ⅓^{rd} reduction in the thermal resistance of the TEC 414 in the unpowered state, as shown in FIG. 5. For example, FIG. 5 illustrates a graph of the thermal resistance (° C./W) of the thermoelectric cooler in an unpowered state with an open circuit versus a shorted (or closed) circuit at varying levels of CPU power (watts), which shows a reduction in the TEC thermal resistance of approximately ⅓^{rd} for the shorted circuit versus the open circuit. As a result, the self-powered mode allows this TEC cooling configuration to manage a full 95 W TDP CPU power load without any power to the TEC cooling module 414.

Turning back to FIG. 4, the thermal affinitizer 444 is used to manage the processor affinity of processes and/or threads executed by the processor 408 based on thermal conditions and performance objectives. Processor affinity refers to the binding or pinning of processes and/or threads to specific processors, cores, and/or virtual cores. In some embodiments, for example, the processor 408 may be a multi-core processor with multiple physical processor cores, and each physical core may be capable of supporting multiple virtual cores or threads, such as simultaneous multithreading (SMT) threads. Moreover, in some cases, a processor affinity may be assigned to a process or thread associated with a particular task/workload, which binds or pins the process/thread to a specific physical core, or virtual core, of the processor 408 (or to a specific processor of a multi-processor system) to improve performance. Setting affinity of a given task (or process) to a specific core (or SMT thread) is a well-known option for software developers. Typically, the decision about setting affinity is managed by the scheduler of an operating system, but there are also tools that allow this to be performed by users.

In the illustrated embodiment, however, the thermal affinitizer 444 utilizes affinitization to maximize thermal performance. For example, by cleverly assigning tasks to certain processor cores, but not others, it is possible to improve the performance of the cores used to execute those tasks. This performance gain is achieved primarily due to the following observations: (i) when fewer cores are active, they are able to run at higher frequencies; (ii) certain cores may be allowed to run—or may be capable of running—at higher frequencies than others; and (iii) the TEC 414 cooling capabilities perform better, and realize power headroom benefits, when less than all processor cores are active. For these reasons, intelligent affinitization policies or algorithms, which factor thermal variables, will enable higher processor frequencies to be achieved for certain workloads (particularly multiple single-threaded tasks).

In some embodiments, for example, the thermal affinitizer 444 is used to concentrate the allocation of processor cores for certain tasks—or their processor affinities—in order to maximize the performance/frequency of the cores used to execute those tasks (e.g., in conjunction with the sub-ambient cooling provided by the TEC 414). For example, the allocation of processor cores used to execute SMT threads may be concentrated on a subset of cores that are strategically selected to achieve more favorable target thermal conditions (e.g., lower processor temperatures) and performance benefits (e.g., higher processor frequencies), which allows those cores to operate higher frequencies/speeds and thus execute the SMT threads faster. In some cases, for example, the allocation of cores for the SMT threads may be concentrated on a single core or a particular subset of cores, such as one or more high performance core(s) capable of running at higher frequencies than the other cores, and/or a particular group of cores chosen to maximize the physical separation between active cores. In this manner, the thermal affinitizer 444 is used to override SMT thread allocation across cores to maximize the frequency increases that can be achieved for certain workloads in conjunction with the TEC 414 cooling solution (e.g., based on the current processor temperature, the risk of condensation, and so forth).

The thermal velocity controller 446 performs automatic frequency control for the processor 408 based on thermal conditions and/or configurable overclocking settings. For example, the thermal velocity controller 446 can automatically adjust the processor frequency based on the current thermal conditions (e.g., processor or CPU temperature), such as by increasing the processor frequency in favorable thermal conditions and reducing the processor frequency in unfavorable thermal conditions.

Moreover, the thermal velocity controller 446 may also support an overclocking mode for providing user-configurable thermal overclocking control. For example, the thermal velocity controller 446 may allow a user to specify various overclocking parameters to control the performance/frequency and thermal conditions of the processor. In some embodiments, for example, the user-configurable overclocking parameters may include a maximum processor temperature, a target processor frequency, target processor voltage, and/or any other parameters relating to overclocking control (e.g., minimum cooling temperature). When the overclocking mode is active, the TEC 414 may be configured to operate at the maximum cooling level or cooling power. Moreover, whenever the current processor temperature is less than or equal to the maximum processor temperature specified by the user, the processor may be configured to run at the target frequency and voltage specified by the user. Whenever the current processor temperature is greater than the maximum processor temperature specified by the user, however, the processor may be configured to run at a reduced frequency and/or voltage lower than those specified by the user. In this manner, the processor frequency and voltage may be automatically adjusted as the current processor temperature fluctuates above and below the maximum processor temperature specified by the user.

As an example, assume a user playing a video game configures the overclocking mode using a target processor frequency of 5.8 GHz and a maximum processor temperature of 23° C. While the user is playing the video game, the processor will run at the target overclocking frequency of 5.8 GHz as long as its temperature remains at or below 23° C. If a temporary spike in the workload causes the processor temperature to rise above 23° C. (e.g., to 25° C.), the processor frequency will be temporarily reduced to avoid crashing until the processor temperature falls back down to 23° C. or below.

In this manner, the overclocking mode enables a user to balance the desired processor performance with varying levels of thermal tolerance (e.g., based on the processor temperature, the risk of condensation, and so forth).

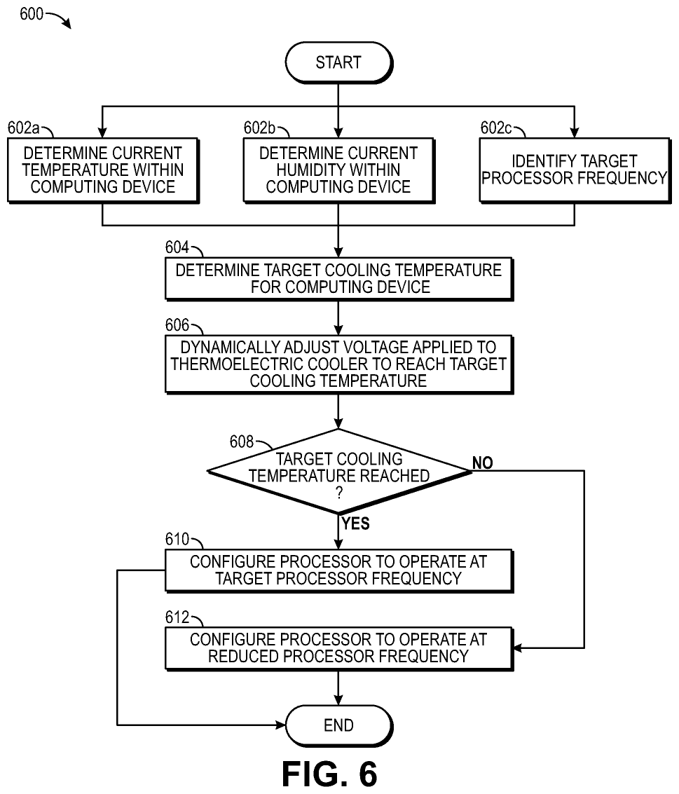

FIG. 6 illustrates a flowchart 600 for dynamically controlling the thermal conditions and performance of a processor using a thermoelectric cooler. In some embodiments, flowchart 600 may be implemented and/or performed using the computing systems and thermoelectric (TEC) cooling devices described throughout this disclosure.

The flowchart begins at blocks 602a-c to determine a current temperature within a computing device (block 602a), determine a current humidity within the computing device (block 602b), and identify the target processor frequency at which to run a processor of the computing device (block 602c).

In some embodiments, for example, the current temperature within the computing device may include the temperature of the processor, the temperature of the PCB/motherboard, and/or the temperature of a cold surface of a TEC cooling system within the computing device. In various embodiments, these respective temperatures may be measured using dedicated thermal sensors, and/or they may be predicted based on temperatures of thermal sensors for other components. In some cases, for example, the current surface temperature of a cold surface within the computing device or TEC cooling system may be predicted based on a current processor temperature measured by a thermal sensor of the processor and one or more thermal characteristics of the processor.

In some embodiments, the humidity within the computing device may be measured using a humidity sensor. Moreover, in some embodiments, the target processor frequency may be specified by a user (e.g., for overclocking purposes).

The flowchart then proceeds to block 604 to determine the target cooling temperature for the computing device. The target cooling temperature may be a target temperature for the computing device to reach via the use of a TEC cooling system to cool the computing device. Moreover, the target cooling temperature for the computing device may be determined based on the current temperature, the current humidity, and the target processor frequency, among other criteria.

In some embodiments, the target cooling temperature may also be determined based on a condensation risk for the computing device. For example, a current dew point for the computing device may be determined based on the current humidity within the computing device, and based on the current dew point, a condensation risk may be predicted for the computing device. The target cooling temperature may then be determined at least partially based on the condensation risk.

The flowchart then proceeds to block 606 to dynamically adjust the voltage of the thermoelectric cooler (TEC) of the computing device to reach the target cooling temperature.

The flowchart then proceeds to block 608 to determine whether the target cooling temperature has been reached.

If the target cooling temperature has been reached, the flowchart then proceeds to block 610 to configure the processor (or a particular core of a multi-core processor) to operate at the target processor frequency.

If the target cooling temperature has not been reached, the flowchart then proceeds to block 612 to configure the processor (or a particular core of a multi-core processor) to operate at a reduced processor frequency (e.g., below the target processor frequency).

At this point, the flowchart may be complete. In some embodiments, however, the flowchart may restart and/or certain blocks may be repeated. For example, in some embodiments, the flowchart may restart at blocks 602a-c to continue measuring temperature and humidity and adjusting the TEC voltage and processor frequency.

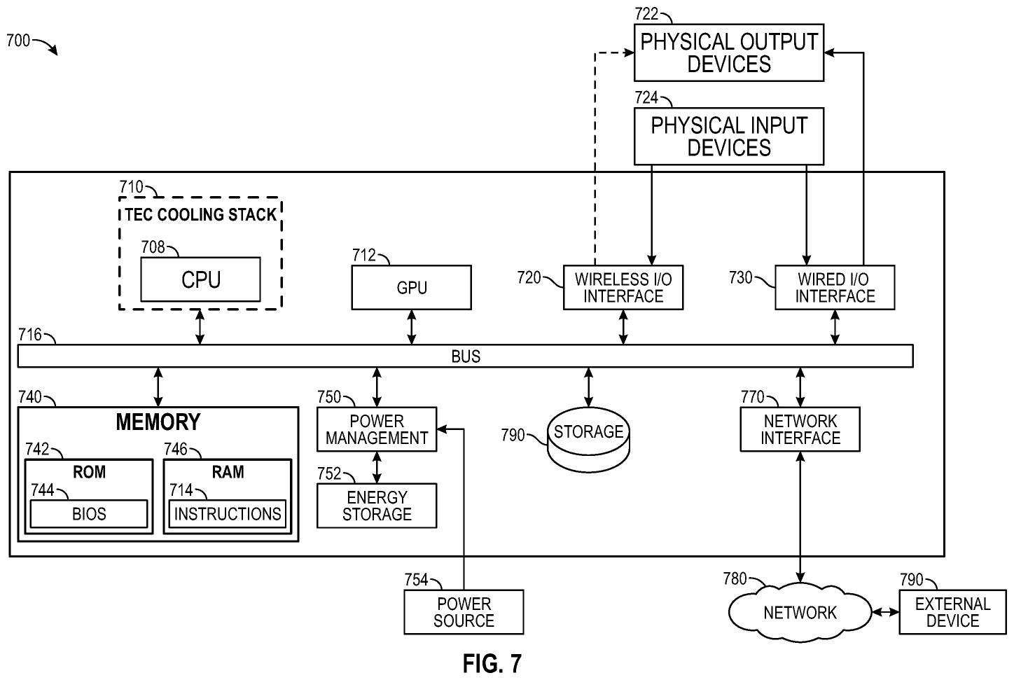

FIG. 7 illustrates an example of a computing device 700 that leverages the thermoelectric cooling functionality described throughout this disclosure. In the illustrated embodiment, for example, the computing device 700 includes a central processing unit (CPU) 708 implemented on a thermoelectric cooling (TEC) stack 710, which provides dynamic thermal cooling control, prevents condensation, and maximizes overall processor performance (e.g., by increasing the maximum frequency/speed at which the CPU core(s) can operate). The TEC cooling stack 710 may be implemented using any combination of features, functionality, and/or components from the thermoelectric cooling embodiments described throughout this disclosure. For example, the TEC cooling stack 710 may include a thermoelectric cooler (TEC) disposed in series between a water block (or any other traditional liquid or air cooler) and the CPU 708. Moreover, a thermal space transformer may be used to thermally couple the CPU 708 to the TEC to transfer thermal energy between the CPU 708 and the cooled surface of the TEC (e.g., spreading heat from the smaller surface of the CPU to the larger cooled surface of the TEC). In some embodiments, an anticondensation shroud may be used to enclose and isolate certain components to protect them from condensation and moisture, including the CPU 708, the TEC, and/or the thermal space transformer. For example, the shroud may form an airtight enclosure around those components that extends from the water block to a printed circuit board (PCB) (e.g., a motherboard). Further, a TEC controller (e.g., which may also be enclosed within the anticondensation shroud) may be used to monitor thermal conditions (e.g., temperature/humidity) and dynamically control the voltage or cooling power of the TEC, thus enabling dynamic cooling and condensation control. In this manner, the TEC cooling stack 710 can reach sub-ambient cooling temperatures while avoiding condensation, which enables the CPU core(s) to operate at their maximum possible clock frequency.

Example, non-limiting computing devices 700 may include, but are not limited to: personal computing devices (e.g., desktops, laptops, video game consoles), servers, mainframes, mobile/portable computing devices (e.g., smartphones, tablets, wearable computing devices, and so forth. Moreover, it should be appreciated that the illustrated embodiment as well as other embodiments may be practiced with configurations and/or components other than those shown.

In the illustrated example, the computing device 700 includes a central processing unit (CPU) 708, a graphics processing unit (GPU) 712, a wireless input/output (I/O) interface 720, a wired I/O interface 730, system memory 740, a persistent storage device 790, power management circuitry 750, and a network interface 770. The following discussion provides a brief, general description of the components forming the illustrative computing device 700.

The computing device 700 includes a bus or similar communications link 716 that communicatively couples and facilitates the exchange of information and/or data between various system components including the CPU 708, the GPU 712, one or more wireless I/O interfaces 720, one or more wired I/O interfaces 730, the system memory 740, one or more network interfaces 770, and/or one or more storage devices 790. The computing device 700 may be referred to in the singular herein, but this is not intended to limit the embodiments to a single computing device 700, since in certain embodiments, there may be more than one computing device 700 that incorporates, includes, or contains any number of communicatively coupled, collocated, or remote/networked circuits or devices.

The CPU 708 and the GPU 712 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

For example, the CPU 708 may include any number, type, or combination of currently available or future developed devices capable of executing machine-readable instruction sets. The CPU 708 may include but is not limited to any current or future developed single- or multi-core processor or microprocessor, such as: on or more systems on a chip (SoCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 7 are of conventional design. Consequently, such blocks need not be described in further detail herein, as they will be understood by those skilled in the relevant art. The bus 716 that interconnects at least some of the components of the computing device 700 may employ any currently available or future developed serial or parallel bus structures or architectures.

The GPU 712 may be capable of executing machine-readable instruction sets 714 to perform graphics rendering and computations, video encoding/decoding, video output signal generation (e.g., generating a video output to be displayed to a system user on a display device), artificial intelligence computations, and/or any other general-purpose and/or special-purpose task suitable for execution on a GPU.

The system memory 740 may include read-only memory (“ROM”) 742 and random access memory (“RAM”) 746. A portion of the ROM 742 may be used to store or otherwise retain a basic input/output system (“BIOS”) 744. The BIOS 744 provides basic functionality to the computing device 700, for example by causing CPU 708 and/or GPU 712 to load and/or execute one or more machine-readable instruction sets 714. In embodiments, at least some of the one or more machine-readable instruction sets 714 cause at least a portion of the CPU 708 and/or GPU 712 to provide, create, produce, transition, and/or function as a dedicated, specific, and particular machine, for example a word processing machine, a digital image acquisition machine, a media playing machine, a gaming system, a communications device, a smartphone, or similar.

The computing device 700 may include at least one wireless input/output (I/O) interface 720. The wireless I/O interface(s) 720 may be communicatively coupled to one or more physical output devices 722 (e.g., tactile devices, video displays, audio output devices, hardcopy output devices), and/or the wireless I/O interface(s) 720 may be communicatively coupled to one or more physical input devices 724 (e.g., pointing devices, touchscreens, keyboards, tactile devices). The wireless I/O interface(s) 720 may include any currently available or future developed wireless I/O interface. Example wireless I/O interfaces include, but are not limited to: BLUETOOTH®, near field communication (NFC), and so forth.

The computing device 700 may include one or more wired input/output (I/O) interfaces 730. The wired I/O interface(s) 730 may be communicatively coupled to one or more physical output devices 722 (e.g., tactile devices, video displays, audio output devices, hardcopy output devices, etc.), and/or the wired I/O interface(s) 730 may be communicatively coupled to one or more physical input devices 724 (e.g., pointing devices, touchscreens, keyboards, tactile devices). The wired I/O interface(s) 730 may include any currently available or future developed I/O interface. Example wired I/O interfaces include, but are not limited to: universal serial bus (USB), IEEE 1394 (“FireWire”), and similar.

The computing device 700 may include one or more communicatively coupled, non-transitory, data storage devices 790. The data storage device(s) 790 may include one or more hard disk drives (HDDs) and/or one or more solid-state storage devices (SSDs). The data storage device(s) 790 may include any current or future developed storage appliances, network storage devices, and/or systems. Non-limiting examples of such data storage devices 790 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 790 may include one or more removable storage devices, such as one or more flash drives, flash memories, flash storage units, or similar appliances or devices capable of communicable coupling to and decoupling from the computing device 700.

The data storage device(s) 790 may include interfaces or controllers (not shown) communicatively coupling the respective storage device or system to the bus 716. The data storage device(s) 790 may store, retain, or otherwise contain machine-readable instruction sets, data structures, program modules, data stores, databases, logical structures, and/or other data useful to the CPU 708 and/or GPU 712 and/or one or more applications executed on or by the CPU 708 and/or GPU 712. In some instances, the data storage device(s) 790 may be communicatively coupled to the CPU 720, for example via the bus 716 or via one or more wired communications interfaces 730 (e.g., Universal Serial Bus or USB); one or more wireless communications interfaces 720 (e.g., Bluetooth®, Near Field Communication or NFC); and/or one or more network interfaces 770 (IEEE 802.3 or Ethernet, IEEE 802.11, or WiFi®, etc.).

Processor-readable instruction sets 714 and other programs, applications, logic sets, and/or modules may be stored in whole or in part in the system memory 740. Such instruction sets 714 may be transferred, in whole or in part, from the data storage device(s) 790. The instruction sets 714 may be loaded, stored, or otherwise retained in system memory 740, in whole or in part, during execution by the CPU 708 and/or GPU 712.

The computing device 700 may include power management circuitry 750 that controls one or more operational aspects of the energy storage device 752. In embodiments, the energy storage device 752 may include one or more primary (i.e., non-rechargeable) or secondary (i.e., rechargeable) batteries or similar energy storage devices. In embodiments, the energy storage device 752 may include one or more supercapacitors or ultracapacitors. In embodiments, the power management circuitry 750 may alter, adjust, or control the flow of energy from an external power source 754 to the energy storage device 752 and/or to the computing device 700. The power source 754 may include, but is not limited to, a solar power system, a commercial electric grid, a portable generator, an external energy storage device, or any combination thereof.

For convenience, the CPU 708, the GPU 712, the wireless I/O interface 720, the wired I/O interface 730, the system memory 740, the power management circuitry 750, the storage device 790, and the network interface 770 are illustrated as communicatively coupled to each other via the bus 716, thereby providing connectivity between the above-described components. In alternative embodiments, the above-described components may be communicatively coupled in a different manner than illustrated in FIG. 7. For example, one or more of the above-described components may be directly coupled to other components, or may be coupled to each other, via one or more intermediary components (not shown). In another example, one or more of the above-described components may be integrated into CPU 708, and/or the GPU 712. In some embodiments, all or a portion of the bus 716 may be omitted and the components are coupled directly to each other using suitable wired or wireless connections.

As used in this disclosure and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the term “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices.

As used in any embodiment herein, the term “circuitry” or “processor” may refer to, for example, singly or in any combination, hardwired circuitry, programmable circuitry such as computer processors comprising one or more individual instruction processing cores, state machine circuitry, and/or firmware that stores instructions executed by programmable circuitry or future computing paradigms including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), desktop computers, laptop computers, tablet computers, servers, smartphones, etc.

As used in any embodiment herein, the term “thermally couple” and variations thereof may refer to any form of coupling between or among components, whether direct or indirect, that enables thermal energy to be transferred between or among those components.

Any of the operations described herein may be implemented in a system that includes one or more mediums (e.g., non-transitory storage mediums) having stored therein, individually or in combination, instructions that when executed by one or more processors perform the methods. Here, the processor may include, for example, a server CPU, a personal computer CPU (e.g., desktop/laptop), a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

### EXAMPLES

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes a computing device, comprising: a processor; a water block; a thermoelectric cooler disposed in series between the processor and the water block, wherein the thermoelectric cooler comprises a heated surface and a cooled surface, wherein the heated surface is thermally coupled to the water block, and wherein the cooled surface is thermally coupled to the processor via a thermal space transformer; and the thermal space transformer, wherein the thermal space transformer is to transfer thermal energy between the processor and the cooled surface of the thermoelectric cooler, wherein a surface area of the processor is smaller than a surface area of the thermoelectric cooler, and wherein the thermal space transformer comprises a smaller surface and a larger surface, wherein the smaller surface is thermally coupled to the processor and the larger surface is thermally coupled to the cooled surface of the thermoelectric cooler.

Example 2 includes the computing device of Example 1, further comprising an anticondensation shroud, wherein the anticondensation shroud encloses the thermoelectric cooler, the thermal space transformer, and the processor within an airtight enclosure, wherein the airtight enclosure is isolated from external ambient air.

Example 3 includes the computing device of Example 1, further comprising a thermoelectric cooler (TEC) controller to dynamically control a voltage applied to the thermoelectric cooler.

Example 4 includes the computing device of Example 3: further comprising a humidity sensor to measure a current humidity within the computing device; and wherein the processor is to: determine a target cooling temperature for the computing device, wherein the target cooling temperature is to be determined based at least in part on the current humidity and a target processor frequency; cause the TEC controller to dynamically adjust the voltage applied to the thermoelectric cooler to reach the target cooling temperature; and configure the processor to operate at the target processor frequency.

Example 5 includes the computing device of Example 4, wherein the processor to cause the TEC controller to dynamically adjust the voltage applied to the thermoelectric cooler to reach the target cooling temperature is further to: determine a current dew point for the computing device, wherein the current dew point is determined based at least in part on the current humidity within the computing device; determine a current temperature within the computing device; predict a condensation risk based at least in part on the current dew point and the current temperature; and determine the target cooling temperature based at least in part on the condensation risk.

Example 6 includes the computing device of Example 5, wherein the processor to determine the current temperature within the computing device is further to: predict a current surface temperature of a cold surface within the computing device, wherein the current surface temperature is predicted based at least in part on: a current processor temperature measured by a thermal sensor of the processor; and one or more thermal characteristics of the processor.

Example 7 includes the computing device of Example 3, wherein the TEC controller is further to configure the thermoelectric cooler to operate in a self-powered mode, wherein the thermoelectric cooler is to be powered off and short-circuited to operate in the self-powered mode.

Example 8 includes the computing device of Example 1, wherein: the processor comprises a plurality of cores, wherein a plurality of tasks are to be executed on at least some of the plurality of cores; and the processor is to determine a processor affinity for executing the plurality of tasks, wherein: the processor affinity is to assign each task of the plurality of tasks to one or more corresponding cores of the plurality of cores; and the processor affinity is to be determined based at least in part on a target processor frequency and a target thermal condition.

Example 9 includes the computing device of Example 1, wherein the processor is to: activate an overclocking mode for the processor based on a set of overclocking parameters configured by a user, wherein the set of overclocking parameters comprises a target processor frequency and a maximum temperature, and wherein: the thermoelectric cooler is to operate at a maximum cooling level; the processor is to operate at the target processor frequency while a current temperature of the processor is less than or equal to the maximum temperature; and the processor is to operate at a reduced processor frequency while the current temperature of the processor is greater than the maximum temperature, wherein the reduced processor frequency is less than the target processor frequency.

Example 10 includes a cooling device for a processor, comprising: a thermoelectric cooler, wherein the thermoelectric cooler is to be disposed in series between the processor and a water block, and wherein the thermoelectric cooler comprises a heated surface and a cooled surface, wherein the heated surface is to be thermally coupled to the water block, and wherein the cooled surface is to be thermally coupled to the processor via a thermal space transformer; and the thermal space transformer, wherein the thermal space transformer is to transfer thermal energy between the processor and the cooled surface of the thermoelectric cooler, wherein a surface area of the processor is smaller than a surface area of the thermoelectric cooler, and wherein the thermal space transformer comprises a smaller surface and a larger surface, wherein the smaller surface is to be thermally coupled to the processor and the larger surface is to be thermally coupled to the cooled surface of the thermoelectric cooler.

Example 11 includes the cooling device of Example 10, wherein the thermal space transformer is further to spread heat from a smaller surface of the processor to a larger surface of the thermoelectric cooler.

Example 12 includes the cooling device of Example 10, wherein the thermal space transformer comprises a thermal interposer.

Example 13 includes the cooling device of Example 10, further comprising an anticondensation shroud, wherein the anticondensation shroud is to enclose the thermoelectric cooler, the thermal space transformer, and the processor within an airtight enclosure, wherein the airtight enclosure is to be isolated from external ambient air.

Example 14 includes the cooling device of Example 13, wherein one or more chemical desiccants are disposed within the anticondensation shroud.

Example 15 includes the cooling device of Example 13, wherein the anticondensation shroud is to be sealed between the water block and a printed circuit board.

Example 16 includes the cooling device of Example 10, further comprising: a humidity sensor to measure a current humidity; and a thermoelectric cooler (TEC) controller to control a voltage applied to the thermoelectric cooler, wherein the voltage is to be dynamically adjusted to reach a target cooling temperature, wherein the target cooling temperature is to be determined based at least in part on the current humidity.

Example 17 includes the cooling device of Example 16, wherein the TEC controller is further to configure the thermoelectric cooler to operate in a self-powered mode, wherein the thermoelectric cooler is to be powered off and short-circuited to operate in the self-powered mode.

Example 18 includes at least one non-transitory machine-readable storage medium having instructions stored thereon, wherein the instructions, when executed on processing circuitry, cause the processing circuitry to: determine a current temperature within a computing device, wherein the computing device comprises a processor and a thermoelectric cooler; identify a target processor frequency for the processor; determine a target cooling temperature for the computing device, wherein the target cooling temperature is to be determined based at least in part on the current temperature and the target processor frequency; dynamically adjust the voltage applied to the thermoelectric cooler to reach the target cooling temperature; and configure the processor to operate at the target processor frequency.

Example 19 includes the storage medium of Example 18, wherein the instructions that cause the processing circuitry to determine the target cooling temperature for the computing device further cause the processing circuitry to: measure a current humidity within the computing device, wherein the current humidity is measured using a humidity sensor; and determine the target cooling temperature for the computing device based at least in part on the current humidity.

Example 20 includes the storage medium of Example 19, wherein the instructions that cause the processing circuitry to determine the target cooling temperature for the computing device based at least in part on the current humidity further cause the processing circuitry to: determine a current dew point for the computing device, wherein the current dew point is determined based at least in part on the current humidity within the computing device; predict a condensation risk based at least in part on the current dew point and the current temperature; and determine the target cooling temperature for the computing device based at least in part on the condensation risk.

Example 21 includes the storage medium of Example 18, wherein the instructions that cause the processing circuitry to determine the current temperature within the computing device further cause the processing circuitry to: predict a current surface temperature of a cold surface within the computing device, wherein the current surface temperature is predicted based at least in part on: a current processor temperature measured by a thermal sensor of the processor; and one or more thermal characteristics of the processor.

Example 22 includes the storage medium of Example 18, wherein: the processor comprises a plurality of cores, wherein a plurality of tasks are to be executed on at least some of the plurality of cores; and the instructions further cause the processing circuitry to determine a processor affinity for executing the plurality of tasks, wherein: the processor affinity is to assign each task of the plurality of tasks to one or more corresponding cores of the plurality of cores; and the processor affinity is to be determined based at least in part on a target processor frequency and a target thermal condition.

Example 23 includes the storage medium of Example 18, wherein the instructions further cause the processing circuitry to: activate an overclocking mode for the processor based on a set of overclocking parameters configured by a user, wherein the set of overclocking parameters comprises a target processor frequency and a maximum temperature, and wherein: the thermoelectric cooler is to operate at a maximum cooling level; the processor is to operate at the target processor frequency while a current temperature of the processor is less than or equal to the maximum temperature; and the processor is to operate at a reduced processor frequency while the current temperature of the processor is greater than the maximum temperature, wherein the reduced processor frequency is less than the target processor frequency.

Example 24 includes a method of cooling a computing device, comprising: determining a current temperature within the computing device, wherein the computing device comprises a processor and a thermoelectric cooler; identifying a target processor frequency for the processor; determining a target cooling temperature for the computing device, wherein the target cooling temperature is determined based at least in part on the current temperature and the target processor frequency; dynamically adjusting the voltage applied to the thermoelectric cooler to reach the target cooling temperature; and configuring the processor to operate at the target processor frequency.

Example 25 includes the method of Example 24, wherein determining the target cooling temperature for the computing device comprises: measuring a current humidity within the computing device, wherein the current humidity is measured using a humidity sensor; determining a current dew point for the computing device, wherein the current dew point is determined based at least in part on the current humidity within the computing device; predicting a condensation risk based at least in part on the current dew point and the current temperature; and determining the target cooling temperature for the computing device based at least in part on the condensation risk.

What is claimed is:

1. A computing device, comprising:
a processor;
a water block;
a thermoelectric cooler disposed in series between the processor and the water block, wherein the thermoelectric cooler comprises a heated surface and a cooled surface, wherein the heated surface is thermally coupled to the water block, and wherein the cooled surface is thermally coupled to the processor via a thermal space transformer; and
the thermal space transformer, wherein the thermal space transformer is to transfer thermal energy between the processor and the cooled surface of the thermoelectric cooler, wherein a surface area of the processor is smaller than a surface area of the thermoelectric cooler, and wherein the thermal space transformer comprises a smaller surface and a larger surface, wherein the smaller surface is thermally coupled to the processor and the larger surface is thermally coupled to the cooled surface of the thermoelectric cooler.

2. The computing device of claim 1, further comprising an anticondensation shroud, wherein the anticondensation shroud encloses the thermoelectric cooler, the thermal space transformer, and the processor within an airtight enclosure, wherein the airtight enclosure is isolated from external ambient air.

3. The computing device of claim 1, further comprising a thermoelectric cooler (TEC) controller to dynamically control a voltage applied to the thermoelectric cooler.

4. The computing device of claim 3:
further comprising a humidity sensor to measure a current humidity within the computing device;
wherein the processor is to:
determine a target cooling temperature for the computing device, wherein the target cooling temperature is to be determined based at least in part on the current humidity and a target processor frequency;
cause the TEC controller to dynamically adjust the voltage applied to the thermoelectric cooler to reach the target cooling temperature; and
configure the processor to operate at the target processor frequency.

5. The computing device of claim 4, wherein the processor to cause the TEC controller to dynamically adjust the voltage applied to the thermoelectric cooler to reach the target cooling temperature is further to:
determine a current dew point for the computing device, wherein the current dew point is determined based at least in part on the current humidity within the computing device;
determine a current temperature within the computing device;
predict a condensation risk based at least in part on the current dew point and the current temperature; and
determine the target cooling temperature based at least in part on the condensation risk.

6. The computing device of claim 5, wherein the processor to determine the current temperature within the computing device is further to:
predict a current surface temperature of a cold surface within the computing device, wherein the current surface temperature is predicted based at least in part on:
a current processor temperature measured by a thermal sensor of the processor; and
one or more thermal characteristics of the processor.

7. The computing device of claim 3, wherein the TEC controller is further to configure the thermoelectric cooler to operate in a self-powered mode, wherein the thermoelectric cooler is to be powered off and short-circuited to operate in the self-powered mode.

8. The computing device of claim 1, wherein:
the processor comprises a plurality of cores, wherein a plurality of tasks are to be executed on at least some of the plurality of cores; and
the processor is to determine a processor affinity for executing the plurality of tasks, wherein:
the processor affinity is to assign each task of the plurality of tasks to one or more corresponding cores of the plurality of cores; and
the processor affinity is to be determined based at least in part on a target processor frequency and a target thermal condition.

9. The computing device of claim 1, wherein the processor is to:
activate an overclocking mode for the processor based on a set of overclocking parameters configured by a user, wherein the set of overclocking parameters comprises a target processor frequency and a maximum temperature, and wherein:
the thermoelectric cooler is to operate at a maximum cooling level;
the processor is to operate at the target processor frequency while a current temperature of the processor is less than or equal to the maximum temperature; and
the processor is to operate at a reduced processor frequency while the current temperature of the processor is greater than the maximum temperature, wherein the reduced processor frequency is less than the target processor frequency.

10. A cooling device for a processor, comprising:
a thermoelectric cooler, wherein the thermoelectric cooler is to be disposed in series between the processor and a water block, and wherein the thermoelectric cooler comprises a heated surface and a cooled surface, wherein the heated surface is to be thermally coupled to the water block, and wherein the cooled surface is to be thermally coupled to the processor via a thermal space transformer; and
the thermal space transformer, wherein the thermal space transformer is to transfer thermal energy between the processor and the cooled surface of the thermoelectric cooler, wherein a surface area of the processor is smaller than a surface area of the thermoelectric cooler, and wherein the thermal space transformer comprises a smaller surface and a larger surface, wherein the smaller surface is to be thermally coupled to the processor and the larger surface is to be thermally coupled to the cooled surface of the thermoelectric cooler.

11. The cooling device of claim 10, wherein the thermal space transformer is further to spread heat from a smaller surface of the processor to a larger surface of the thermoelectric cooler.

12. The cooling device of claim 10, wherein the thermal space transformer comprises a thermal interposer.

13. The cooling device of claim 10, further comprising an anticondensation shroud, wherein the anticondensation shroud is to enclose the thermoelectric cooler, the thermal space transformer, and the processor within an airtight enclosure, wherein the airtight enclosure is to be isolated from external ambient air.

14. The cooling device of claim 13, wherein one or more chemical desiccants are disposed within the anticondensation shroud.

15. The cooling device of claim 13, wherein the anticondensation shroud is to be sealed between the water block and a printed circuit board.

16. The cooling device of claim 10, further comprising:
a humidity sensor to measure a current humidity; and
a thermoelectric cooler (TEC) controller to control a voltage applied to the thermoelectric cooler, wherein the voltage is to be dynamically adjusted to reach a target cooling temperature, wherein the target cooling temperature is to be determined based at least in part on the current humidity.

17. The cooling device of claim 16, wherein the TEC controller is further to configure the thermoelectric cooler to operate in a self-powered mode, wherein the thermoelectric cooler is to be powered off and short-circuited to operate in the self-powered mode.

18. At least one non-transitory machine-readable storage medium having instructions stored thereon, wherein the instructions, when executed on processing circuitry, cause the processing circuitry to:
determine a current temperature within a computing device, wherein the computing device comprises a processor and a thermoelectric cooler;
identify a target processor frequency for the processor;
determine a target cooling temperature for the computing device, wherein the target cooling temperature is to be determined based at least in part on the current temperature and the target processor frequency;
dynamically adjust the voltage applied to the thermoelectric cooler to reach the target cooling temperature; and
configure the processor to operate at the target processor frequency.

19. The storage medium of claim 18, wherein the instructions that cause the processing circuitry to determine the target cooling temperature for the computing device further cause the processing circuitry to:
measure a current humidity within the computing device, wherein the current humidity is measured using a humidity sensor; and
determine the target cooling temperature for the computing device based at least in part on the current humidity.

20. The storage medium of claim 19, wherein the instructions that cause the processing circuitry to determine the target cooling temperature for the computing device based at least in part on the current humidity further cause the processing circuitry to:
determine a current dew point for the computing device, wherein the current dew point is determined based at least in part on the current humidity within the computing device;
predict a condensation risk based at least in part on the current dew point and the current temperature; and
determine the target cooling temperature for the computing device based at least in part on the condensation risk.

21. The storage medium of claim 18, wherein the instructions that cause the processing circuitry to determine the current temperature within the computing device further cause the processing circuitry to:
predict a current surface temperature of a cold surface within the computing device, wherein the current surface temperature is predicted based at least in part on:
a current processor temperature measured by a thermal sensor of the processor; and
one or more thermal characteristics of the processor.

22. The storage medium of claim 18, wherein:
the processor comprises a plurality of cores, wherein a plurality of tasks are to be executed on at least some of the plurality of cores; and
the instructions further cause the processing circuitry to determine a processor affinity for executing the plurality of tasks, wherein:
the processor affinity is to assign each task of the plurality of tasks to one or more corresponding cores of the plurality of cores; and
the processor affinity is to be determined based at least in part on a target processor frequency and a target thermal condition.

23. The storage medium of claim 18, wherein the instructions further cause the processing circuitry to:
activate an overclocking mode for the processor based on a set of overclocking parameters configured by a user, wherein the set of overclocking parameters comprises a target processor frequency and a maximum temperature, and wherein:
the thermoelectric cooler is to operate at a maximum cooling level;
the processor is to operate at the target processor frequency while a current temperature of the processor is less than or equal to the maximum temperature; and
the processor is to operate at a reduced processor frequency while the current temperature of the processor is greater than the maximum temperature, wherein the reduced processor frequency is less than the target processor frequency.

24. A method of cooling a computing device, comprising:
determining a current temperature within the computing device, wherein the computing device comprises a processor and a thermoelectric cooler;
identifying a target processor frequency for the processor;
determining a target cooling temperature for the computing device, wherein the target cooling temperature is determined based at least in part on the current temperature and the target processor frequency;
dynamically adjusting the voltage applied to the thermoelectric cooler to reach the target cooling temperature; and
configuring the processor to operate at the target processor frequency.

25. The method of claim 24, wherein determining the target cooling temperature for the computing device comprises:
measuring a current humidity within the computing device, wherein the current humidity is measured using a humidity sensor;
determining a current dew point for the computing device, wherein the current dew point is determined based at least in part on the current humidity within the computing device;
predicting a condensation risk based at least in part on the current dew point and the current temperature; and
determining the target cooling temperature for the computing device based at least in part on the condensation risk.
